(19) United States
(12) Patent Application Publication
(10) Pub. No.: US 2026/0228435 A1
(43) Pub. Date: Aug. 6, 2026

(54) QUERY SEQUENCE OBFUSCATION USING LARGE LANGUAGE MODEL GENERATION OF DECOY TOPICS

(71) Applicant: International Business Machines Corporation, Armonk, NY (US)

(72) Inventors: David James Beymer, San Jose, CA (US); Dinesh C. Verma, New Castle, NY (US); PAWAN RAGHUNATH CHOWDHARY, San Jose, CA (US); Swanand Ravindra Kadhe, San Jose, CA (US)

(21) Appl. No.: 19/042,142

(22) Filed: Jan. 31, 2025

(51) Int. Cl. G06F 40/30; G06F 16/334

(52) U.S. Cl. CPC G06F 40/30; G06F 16/3347

(57) ABSTRACT

Mechanisms are provided for obfuscating query sequences using a large language model (LLM) semantic embedding space. The mechanisms receive a user search query sequence comprising at least one pairing of a first user search query and a second user search query that is subsequent to the first user search query in the user search query sequence. The mechanisms generate, for the pairing, a difference vector between a vector embedding of the second user search query and a vector embedding of the first user search query. The mechanisms apply the difference vector to a vector embedding of a previous decoy search query to generate a subsequent decoy search query in a decoy search query sequence. The vector embeddings of the first user search query, second user search query, and the previous decoy search query are generated by a LLM based on a semantic embedding space associated with the LLM.

### BACKGROUND

The present application relates generally to a data processing apparatus and method and more specifically to a computing tool and computing tool operations/functionality for obfuscating query sequences using large language model generation of decoy topics.

Search engines are a critical element to the use of large scale data networks having numerous computing systems providing numerous sources of content. Search engines allow users to enter textual search terms to search for content provided by and via these computer systems and the data networks connecting them. These search engines include Google® (a registered trademark of Google, Inc.), Microsoft Bing® (a registered trademark of Microsoft Corporation), Yahoo® (a registered trademark of Yahoo, Inc.), and the like.

These search engines often must rely on advertising and fee-based promotions of certain content providers over others in order to operate. In order to serve users better, provide better advertisements that are of greater interest to the users, and provide a more engaging experience for users, these search engine providers often build user profiles based on the search queries that the user's submit to the search engine. The user profiles may then be used for various functionality, such as populating the advertisements in areas around the search engine interface, providing text completion suggestions as the user is typing, change various aspects of the presentation of the search engine web page, and the like.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises receiving a user search query sequence comprising at least one pairing of a first user search query and a second user search query that is subsequent to the first user search query in the user search query sequence. The method further comprises generating, for the pairing, a difference vector between a vector embedding of the second user search query and a vector embedding of the first user search query. The method also comprises applying the difference vector to a vector embedding of a previous decoy search query seed to generate a subsequent decoy search query in a decoy search query sequence. The vector embeddings of the first user search query, second user search query, and the previous decoy search query are generated by a large language model (LLM) based on a semantic embedding space associated with the LLM.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram of a decoy query sequence generator in accordance with one illustrative embodiment;

FIG. 3 is an example diagram illustrating a pattern of search queries in a search query sequence within a semantic vector space and reproduction of the pattern with regard to a seed decoy query in accordance with one illustrative embodiment;

FIG. 4 is a diagram depicting example user and decoy sequences generated using the mechanisms of the illustrative embodiments; and

FIG. 5 presents a flowchart outlining example operations of elements of the present invention with regard to one or more illustrative embodiments

### DETAILED DESCRIPTION

The illustrative embodiments provide an improved computing tool and improved computing tool operations/functionality for obfuscating query sequences using large language model (LLM) generation of decoy topics. The illustrative embodiments leverage the encodings generated by LLMs in a semantically generated vector space of the LLM as a way of providing non-fixed paths to finding terms/phrases for generation of decoy queries in decoy query sequences. Moreover, the illustrative embodiments use vector differencing between pairings of subsequent queries to determine the pathway for generation of decoy query sequences by applying a similar vector difference to subsequent decoy queries in the decoy query sequence. As a result, the decoy query sequences more closely represent the coherency and topic development pattern of the original input query but with regard to decoy query topics. Hence, an entity attempting to distinguish the real query sequence from the decoys will be less likely to identify the real query sequence.

As noted above, information and content held by content and service providers is frequently accessed through search engines. Users of the content/service providers submit search queries to a search engine to locate the desired content/information and gain access to the content/information through hyperlinks and the like. In some cases, the users may not want their search queries to be revealed to the providers of these search engines, the content/service providers, and/or other entities with access to the search engine and/or the data stored in user profiles, histories of search queries submitted to the search engines, and the like. For example, users could be employees and/or other members of an enterprise, or another entity and may not want search queries regarding work in potential areas of strategic importance to be revealed outside the enterprise. In another example, users may search private information, e.g., health conditions, symptoms, financial status information, and the like, which they may not wish to have discoverable by other entities. Thus, it is important to be able to conceal these interactions with search engines so as to protect the identity and/or private information associated with a user.

The search queries may be concealed by concealing the identity of the user and/or concealing the search query itself. Methods for concealing the identity of the user do not work on application-level mechanisms (e.g., cookies) and/or the concealed identity results in access to desired information being restricted (e.g., blocked by a pay wall). Methods for concealing the search query itself include using fixed sets of other terms to generate decoy/proxy queries. The decoy/proxy queries are generated and submitted to the search engine similar to the real queries, so as to attempt to keep entities from being able to differentiate the real query from the decoy query, but with search results being provided back to the user for only the real query such that the user is not aware of the generated decoys.

For example, some solutions use a fixed ontology of terms/phrases where fixed branches of the tree-like hierarchy of the ontology may be followed to generate random replacements for terms/phrases in the original input query. This results in decoy query sequences that follow a fixed and somewhat limited number of topic changes, as specified by a fixed, human-curated ontology. In our approach, using the LLM embedding space, opens up a considerably larger number of topic changes, as the embedding space is high dimensional.

Accordingly, there has been a need for a more robust method of obfuscating search queries such that original search queries are not easily identifiable or distinguishable amidst decoy queries. In commonly owned and co-pending U.S. patent application Ser. No. 18/794,550 (Attorney Docket No. P202305345US01), assigned to the same assignee as the present application, mechanisms are provided to obfuscate search queries using language models in conjunction with sets of known terms. Such an approach results in the generation of decoy queries which are much harder to identify than those generated using current methods. The approach in this commonly owned and co-pending U.S. Patent Application generates decoy queries that are hard to distinguish from the original query by using ontologies of known terms and language model embeddings to generate alternative query terms/phrases that lead to higher levels of association based on these embeddings of the input query and the candidate queries using the alternative terms/phrases. Thresholds of required levels of association for sufficient obfuscation of the original query may be established, to which scores of the candidate queries may be compared to ensure a sufficient level of association to allow for sufficient obfuscation of the original input query.

Thus, as can be seen from the above discussion, query obfuscation is designed to obfuscate single queries on a one-by-one basis. However, it has been determined that users often submit sequences of queries directed to a topic, such as by trying different ways of posing a query, adding additional query criteria in subsequent queries, or the like. For example, often users may submit a more general query to see if they can get search results that have useful content/information but then determine that what they are looking for is not adequately represented in the search results. Subsequently, the user submits another search query with different search criteria in an attempt to find the content/information they need, where the search query may have alternative terms, additional search criteria to more specifically identify the topic of interest, and/or the like.

These sequences of queries can reveal information as well and may be able to clearly identify which search queries are the actual or real search queries based on the clear development of a topic across all the search queries. That is, if one correlates these queries and determines what the user is actually looking for, private information or search query topics that the user may wish to keep from the search engine provider may be inadvertently divulged and the coherency between the search queries is a clear indicator of which queries are the real queries as opposed to decoy/proxy queries which will be more randomized. For example, if a user first searches a disease, and then in subsequent searches search other related searches, perhaps adding additional search criteria, one may deduce from the sequence that a particular user may have the particular disease. In a more benign example, if a user is searching a topic of “soccer”, the user may submit a sequence or series of related queries (q0, q1, q2, qn−1), such as “soccer”, “soccer America”, “US women's soccer team”, and the like.

In order to obfuscate sequences of queries, current art obfuscates each individual query independent of each other query in the sequence, such as described previously. Most existing art, apart from the above commonly owned and co-pending application, obfuscates the queries randomly, resulting in decoy queries that have terms/phrases that are not related to the original query. As a result, sequences of decoy queries appear to be random relative to one another. The mechanisms of the co-pending application if applied to individual queries of a search query sequence can obfuscate individual queries in isolation, but the sequence of decoy queries can still appear more random than the original input query sequence. This will allow entities to distinguish the real input query sequence as it will have a relatively lower randomness or dissimilarity between the queries than the decoy query sequences.

In machine learning and large language models, the notion of a text passage having lower randomness or “making more sense” is related to a probability measure called perplexity. Perplexity is a measure of how well an LLM model can “explain” an input text passage, and lower perplexity scores correspond to higher probability measures and are hence more “explainable”. A true query sequence that develops a query topic would be well explainable by an LLM, so it would have low perplexity, while a set of randomly chosen, unrelated queries would have high perplexity. Thus, a true query sequence with low perplexity could be distinguished from randomly chosen decoys (with higher perplexity) by an automated adversary simply by using perplexity as a metric.

For example, if an original search query sequence is as above, i.e., (soccer, soccer America, US women's soccer team), one can see a similarity between each query in that each query has something to do with the sport of soccer. When generating decoy queries based on the input query, the resulting decoy query sequence will have a higher randomness between pairs of subsequent queries, e.g., one decoy query sequence may be (swimming, monster truck rally, US energy production), another may be (lacrosse, submarine, San Francisco Philharmonic), and a third may (tennis, musical theater program, European Central Bank). It can be seen from this example, that if presented with the decoys and the original input sequence, such as in a search query history or the like, it will be easy to distinguish the real input sequence from the decoys due to the relative similarity between subsequent queries in the input sequence compared to the decoy sequences. That is, the decoy sequences will have a high perplexity relative to the perplexity of the original search query sequence and thus, may be distinguishable from the original search query sequence.

Thus, there is a need to be able to obfuscate search query sequences by generation of decoy query sequences, but in a manner where it is difficult to distinguish the input query sequence from the decoy query sequences. The illustrative embodiments provide a computing tool and computing tool operations/functionality that improve the decoy query sequence generation such that the decoy query sequences mirror a similar topic/concept development across pairings of subsequent queries in the input query sequence but with the generation of the decoy query sequences. The illustrative embodiments implement large language model (LLM) type encodings in a semantic vector space as a way of generating decoy query sequences that resemble the way in which a user develops a search query sequence such that the decoy query sequence appears to be more like actual user submitted query sequences, and thereby keeping the perplexity of the original user sequence and decoy sequences similar.

The illustrative embodiments leverage the encodings generated by LLMs in a semantically generated vector space of the LLM as a way of providing non-fixed paths to finding terms/phrases for generation of decoy queries in decoy query sequences. The semantic vector space is a computational representation where lexical items (words or multi-word terms) are represented as vectors or embeddings. These vectors capture distributional characteristics and are used to measure similarity between words, phrases, or entire documents. In particular, semantic vector spaces capture the meaning of words or multi-word phrases as high-dimensional vectors that represent the complex semantic relationships (e.g., synonyms, antonyms, hypernyms, hyponyms, etc.) between words based on the distribution of their occurrences in large corpora of electronic documents. In the semantic vector space, the distance between two vectors reflects the semantic similarity between the corresponding words or multi-word phrases.

Within the semantic vector space, there is virtually an infinite number of different directions that one can move within the semantic vector space to generate decoy queries. That is, the pathways between words/phrases is not fixed, such as in the ontology based mechanisms discussed above. Thus, using the semantic vector space, the decoy generation mechanisms are free to move in any direction suitable to mirror the user submitted real queries. Hence, given a first real query in a query sequence, a seed decoy query may be generated using the semantic vector space. Thereafter, with each subsequent user submitted search query in the search query sequence, the user's pattern of moving from one search query to the next will be mirrored in the semantic vector space with regard to the seed decoy query. Thus, the resulting decoy query sequence will resemble the same pattern and hence will more closely resemble an actual user search query sequence, making the real query sequence less likely to be able to be distinguished from the decoy. This may be done with regard to a plurality of seed decoys such that distinguishing the real query sequence is even less likely, i.e., the perplexity is similar to the true query sequence, where “similar” may be specified by a predefined acceptable amount of difference or tolerance between the perplexity of the decoy query sequence and the true query sequence.

In order to determine the patterns of queries in a search query sequence, the illustrative embodiments use vector differencing between pairings of subsequent queries to determine the pathway or pattern followed by the user in submitting the real queries of the real query sequence, such that it may be applied to the seed decoy query. That is, the vector difference between embeddings of adjacent search queries (pairings of a previous search query and a subsequent search query) may be applied to the seed decoy, or the current decoy query of the decoy query sequence, for generation of a subsequent decoy query in the decoy query sequences. By applying a similar vector difference to subsequent decoy queries in the decoy query sequence, the decoy query sequences more closely represent the coherency and concept/topic development pattern of the original input query but with regard to decoy query topics.

For example, with the mechanisms of the illustrative embodiments, given a user's initial query of a sequence, such as “soccer”, an initial seed decoy query may be of the type “lacrosse”, as lacrosse is semantically similar to soccer in that it is also a sport. Now, assume that the user submits a subsequent real query of “Soccer America”. The initial query of “soccer” and the subsequent query “Soccer America” are represented as vectors using the LLM embedding in the semantic vector space of the LLM. The vector difference between these two vectors is determined to determine a movement within the semantic vector space from the first vector (initial query) to the second vector (second query). This vector difference is applied to the seed decoy query to generate a second decoy query. Thus, a similar movement within the semantic vector space is performed, but is performed with regard to the seed decoy query. This may result in a second decoy query of “American Lacrosse League” for example. This process may be repeated with each subsequent query, such that the actual query sequence and the decoy query sequence may be as follows:
Real Query Sequence: [“soccer”, “Soccer America”, “US Women's Soccer Team”]
Decoy Query Sequence: [“lacrosse”, “American Lacrosse League”, “National Women's Lacrosse League”]
   This can be repeated with multiple decoy seed queries so that multiple decoy query sequences may be generated. For example, additional decoy query sequences may be of the type:
[“swimming”, “Night Swimming”, “Artistic swimming at the 2020 Summer Olympics—Women's team”]
[“baseball”, “Baseball America”, “Ladies League Baseball”]
[“tennis”, “Everybody's Tennis”, “NAIA Women's Tennis Championship”]

As can be seen from the above examples, the decoy query sequences more closely resemble the real (or “true”) query sequence than if one were to use the individual query obfuscation techniques discussed above, e.g., the random term/phrase replacement or the less random term/phrase replacement of the commonly owned and co-pending U.S. Patent Application.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a large language model (LLM) based decoy search query sequence generator. The improved computing tool implements mechanism and functionality, such as the LLM-based decoy search query sequence generator, which cannot be practically performed by human beings either outside of, or with the assistance of, a technical environment, such as a mental process or the like. The improved computing tool provides a practical application of the methodology at least in that the improved computing tool is able to generate decoy search query sequences that more closely resemble actual user submitted query sequences by using similar patterns of search queries as represented in a semantic vector space.

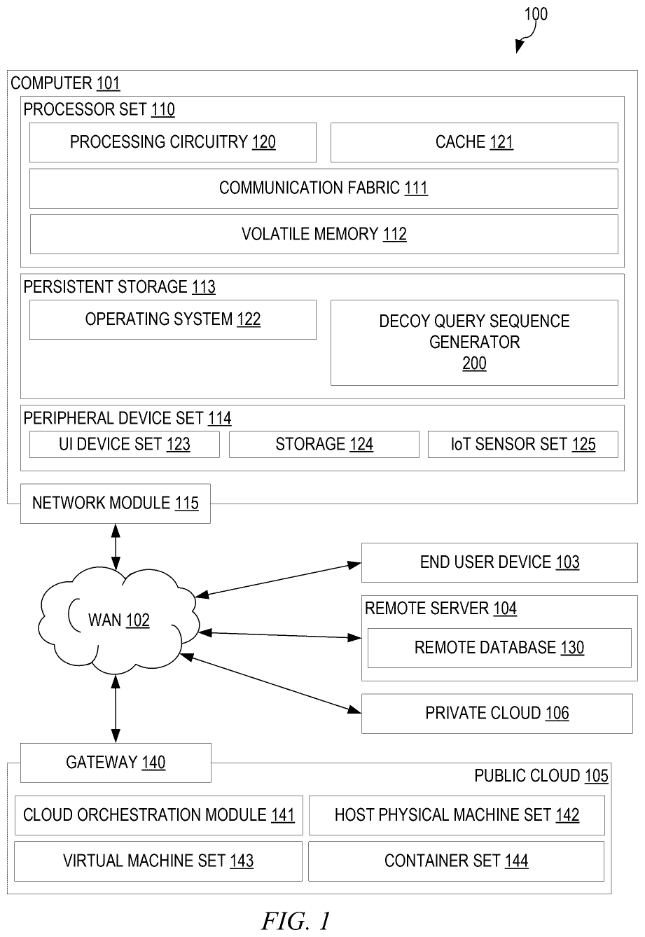

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as LLM-based decoy search query sequence generator 200, hereafter referred to as decoy query sequence generator 200. In addition to decoy query sequence generator 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and decoy query sequence generator 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in decoy query sequence generator 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in decoy query sequence generator 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a decoy query sequence generator 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates decoy search query sequence generation in a manner that make distinguishing the real or actual search query sequence from the decoy search query sequences more difficult, i.e., maintains a similar level of perplexity (perplexity within a given tolerance or threshold level of difference).

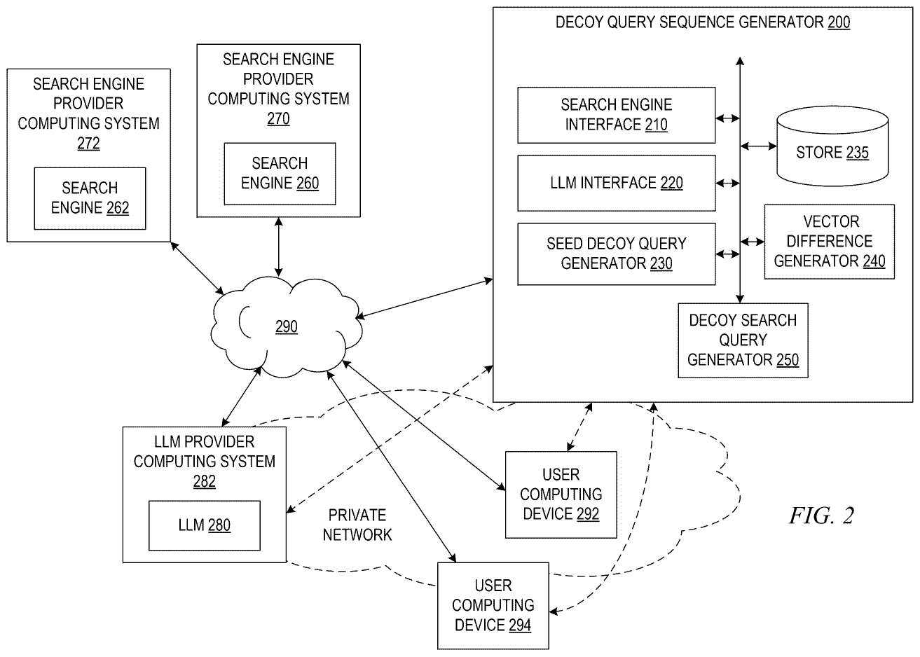

FIG. 2 is an example block diagram illustrating the primary operational components of a decoy query sequence generator in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that decoy search queries and decoy search query sequences are generated to obfuscate real or actual user submitted search queries. The invention provides a specific solution that implements large language model (LLM) semantic vector space embeddings to determine the pattern of query sequences such that they can be reproduced when generating decoy query sequences, which cannot be practically performed by human beings as a mental process and is not directed to organizing any human activity.

As shown in FIG. 2, the decoy query sequence generator 200 includes a search engine interface 210, a large language model (LLM) interface 220, a seed decoy query generator 230, a vector difference generator 240, and a decoy search query generator 250. The decoy query sequence generator 200 may operate in conjunction with one or more search engines 260, 262 provided by one or more search engine provider computing systems 270, 272. The decoy query sequence generator 200 may further operate in conjunction with a LLM 280 provided by a LLM provider computing system 282. The communication between the decoy query sequence generator 200 and these search engine provider computing systems 270, 272 and the LLM provider computing system 282 may be facilitated via one or more data networks 290. The search engines 260, 262 of the search engine provider computing systems 270, 272 may be provided with search queries from one more user computing devices 292, 294 via the decoy query sequence generator 200 along with decoy queries generated by the decoy query sequence generator 200, such that the search engine providers, if compiling a user profile or otherwise storing a history of queries, will also store the decoy queries of the decoy query sequences. Hence, if an entity (e.g., human or automated computing tool) thereafter attempts to determine the actual query sequence submitted by the user, the entity will not be able to easily distinguish the actual query sequence from these decoy query sequences.

It should be appreciated that while the decoy query sequence generator 200 is shown as a separate entity from user computing devices 292, 294, the illustrative embodiments are not limited to this particular depicted arrangement. To the contrary, in other illustrative embodiments, the decoy query sequence generator 200 may be integrated with each of the user computing devices 292, 294 and/or the decoy query sequence generator 200 may be part of a private network with user computing devices 292, 294. For example, the decoy query sequence generator 200 may execute as a plugin on the user's browser executing on a user computing device 292, 294, or may be on a proxy server inside a private network “close” to the user computing devices 292, 294, e.g., behind a corporate firewall or a personal virtual private network (VPN). Thus, in some illustrative embodiments, the decoy query sequence generator 200 may be integrated with, or on a private network with, the user computing devices 292, 294 which are the sources of user search queries, and in other illustrative embodiments, these elements may be separate and communicate via the data network(s) 290. Other architectures and configurations that may be apparent to those of ordinary skill in the art in view of the present description are likewise considered to be within the spirit and scope of the present invention.

The search engine interface 210 provides a data communication pathway and computing logic for performing data communications with search engines 260, 262. The search engine interface 210 may further comprise logic for intercepting search queries submitted by users of user computing devices 292, 294, such as via their web browsers and the like, prior to submission to the search engine 260, 262. For example, client code may be installed as an extension to the web browser of the user's computing device 292, 294 to perform redirects of search queries to redirect them to the decoy query sequence generator 200 for generation of decoy search query sequences. Thus, a user may navigate, via their web browser, to a search engine webpage and, via a user interface of the search engine, submit a search query which is redirected by the client code at the web browser to the decoy query sequence generator 200, but which is also submitted to the search engine 260, 262 either directly from the user computing device 292, 294 or by forwarding by the decoy query sequence generator 200.

In response to receiving a user search query, i.e., an actual or real search query, the user search query may be input to a utility function (e.g., “encode”) of the LLM 280 which takes sentences or text fragments as input and outputs an embedding of these sentences/text fragments. In practice, the embedding is generated by the utility function by tokenizing input sentences/text fragments which breaks up the text into “tokens” which are short words or fragments of longer words. Each token's embedding is then looked up in a large matrix in the LLM (of size #tokens×embedding dimension). This matrix is computed when the LLM, e.g., LLM 280, was originally trained and thus, this is a quick lookup operation in the resulting matrix. The embeddings of the tokens of a sentence/text fragment are then averaged to get the embedding of the entire sentence/text fragment.

One example of such a function is the model.encode( . . . ) function of the SBERT sentence transformer available at SBERT.net. This example utility loads an LLM model (e.g., the “model=SentenceTransformer( . . . )” line) and then three sentences are entered as input. These three sentences are passed through the model.encode( . . . ) function to obtain the embeddings. In this particular cased, the resulting embeddings are a 3×384 matrix (3 sentences, 384-dimensional embedding space for this LLM). It should be appreciated that this is only one example tool that may be used to generate the embedding and any other currently available or later developed LLM embedding tool may be used without departing from the spirit and scope of the present invention.

Similarly, once the seed decoy query generator 230 generates a distractor seed topic, the LLM embedding of this topic is computed. In some illustrative embodiments, the seed decoy query may be generated using a process such as described in commonly owned and co-pending U.S. patent application Ser. No. 18/794,550 (Attorney Docket No. P202305345US01). In other illustrative embodiments, the seed decoy query may be generated using any known mechanism for randomly generating a decoy search query. It is preferable that the seed decoy query being generated using a similar topic as the user query and thus, the categorization mechanisms of the commonly owned and co-pending application are preferred, but not necessary to the functionality of the illustrative embodiments. To the contrary, any suitable seed decoy query generation tool may be used without departing from the spirit and scope of the present invention.

The seed decoy is similarly submitted to the LLM 280 via the LLM interface 220 for embedding in the semantic vector space of the LLM 280. The embeddings for both the user and decoy search query searches are stored in the user query and decoy query sequence store 235. Thus, when a user's session with a search engine is initiated, the user submits an initial search query which initiates the operation of the decoy query sequence generator 200 and causes the initial set of embeddings for the user search query and the seed decoy search query to be generated and stored in a session related data structure in the user query and decoy query sequence store 235. The data structure stores the history of the session by storing user search query embeddings and corresponding decoy search queries so that only results generated by the search engine for the user's search queries are returned to the user computing device 292, 294, and decoy search queries, while being intermixed and submitted to the search engine 260, 262 along with the user queries, are able to be distinguished by the decoy query sequence generator 200 such that the results from the decoy queries are not returned to the user computing device 292, 294. That is, the search engine results for decoy search queries are filtered out by the decoy query sequence generator 200 without the knowledge of the search engine 260, 262. This also allows for the operation of the decoy query sequence generator 200 to be conducted as a background process for obfuscating the user's query sequence without the user perceiving the background process.

Thereafter, when a user submits a subsequent query in the same session, the subsequent query is likewise embedded using the LLM 280 and the subsequent query's vector representation in the semantic vector space of the LLM 280 is stored in the data structure of the store 235. However, the decoy query corresponding to the subsequent query is generated by the decoy search query generator 250 based on a vector difference generated by the vector difference generator 240. That is, the previous user search query vector representation and the currently received user search query vector representation are provided to the vector different generator 240 which determines a vector difference between the vector representations of the pairing. Thus, for example, if the vector embedding of original user search query is designated q0, and the vector embedding of subsequent user query is designated q1, then the vector difference between q1 and q0 is generated by the vector difference generator 240. This vector difference generation may then be performed for each subsequent pairings of subsequent search queries via the vector difference generator 240, i.e., q1−q0, q2−q1, q3−q2, etc.

The vector differences are provided to the decoy search query generator 250 which applies the vector difference to corresponding decoy query embeddings in the data structure of store 235. Thus, based on the vector difference q1−q0, i.e., Δq₁₋₀, a subsequent decoy search query is generated by the decoy search query generator by applying that vector difference to the vector representation of the corresponding decoy search query, referenced as “dn” similar to the use search query “qn” where n is an incremented integer value with each user query submitted. For example, the decoy search query corresponding to the first search query q1 of the pairing would be d1 in this example and the vector difference Δq₁₋₀ is applied to d0 to generate a subsequent decoy search query d1 in the decoy search query sequence.

The subsequent decoy search query d1 is, by construction, embedded in the semantic vector space of the LLM 280 by virtue of the vector representations of the user search queries and the previous decoy search query and the application of the vector difference. Thus the subsequent decoy search query, along with any other generated decoy search queries, must be converted back into search terms and phrases that can be processed by a search engine 260, 262. Hence the decoy search query generator 250 can utilize a known technology to convert the vector representation of the decoy search query back into a textual search query having corresponding terms and phrases. The resulting textual representation of the decoy search query is submitted to the search engine 260, 262 along with the actual user submitted search queries so that the decoys obfuscate the actual user submitted search queries.

The vector embeddings of the subsequent decoy search queries d2, d3, etc. are stored in the data structure of the store 235 so as to maintain a history of the vector embeddings of the user submitted queries and generated decoy search queries. This history in the data structure of the store 235 may be used in filtering out search engine results corresponding to decoy search queries as well as may be used as a basis for performing the vector difference generation by the vector difference generator 240 and decoy search query generation by the decoy search query generator 250.

Thus, with the mechanisms of the illustrative embodiments, user queries of a user query sequence are embedded into vector embeddings by an LLM using the LLM's semantic vector space. Similarly, a seed decoy search query is embedded by the LLM. With each subsequent user query, a difference vector is generated between the vector embedding of the subsequent user query and the vector embedding of the previous user query. This difference vector is then applied to the vector embedding of the last decoy search query to generate the next decoy search query. This results in a user search query sequence and a corresponding generated decoy search query sequence. The vector embeddings are re-normalized and mapped to words for submission to the search engine such that the search engine, if maintaining a history or building a user profile, cannot differentiate between actual or real user search query sequences and decoy search query sequences due to both types of sequences following patterns of search queries that are similar to one another with regard to development of a topic set forth in the initial search query/seed decoy search query.

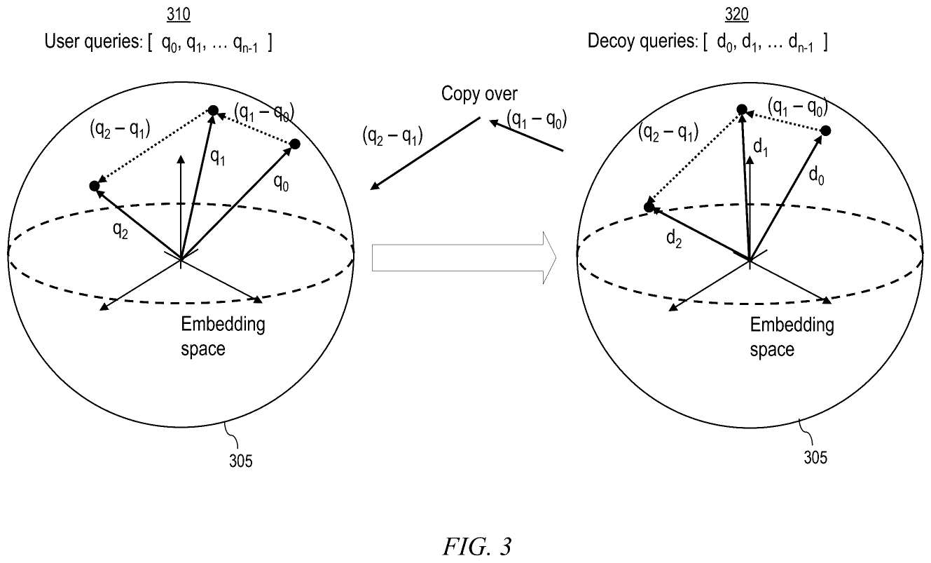

FIG. 3 is an example diagram illustrating a pattern of search queries in a search query sequence within a semantic vector space and reproduction of the pattern with regard to a seed decoy query in accordance with one illustrative embodiment. As shown in FIG. 3, when applying a pattern of search queries from the user submitted actual/real search queries 310 to the decoy search queries 320 in the semantic vector space, represented as the three dimensional sphere of the embedding space 305 in FIG. 3, an embedding of the initial user submitted query q0 is generated. A corresponding embedding of the seed decoy search query is generated d0. Thereafter, the user may submit a second query in the query sequence which results in an embedding of the second query q1. A difference vector between the first query q0 and the subsequent query q1 is generated, as represented by the arrow (q1−q0). This same vector difference is applied to the decoy search query d0 to generate subsequent decoy search query d1. The same process is follows for search query q2 to generate decoy search query d2.

As can be seen from FIG. 3, the same sequence of difference vectors (q1−q0) and (q2−q1) are present with regard to the user submitted query sequence [q0, q1, q2] and decoy query sequence [d0, d1, d2]. Thus, the sequences follows a similar pattern such that the decoy query sequence represents a similar development of the topic in the original query. A third party entity looking at both sequences would not be able to determine which sequence was the user submitted sequence and which was the automatically generated decoy sequence. Hence, the user submitted sequence is obfuscated by decoys with similar levels of perplexity, so no particular sequence stands out.

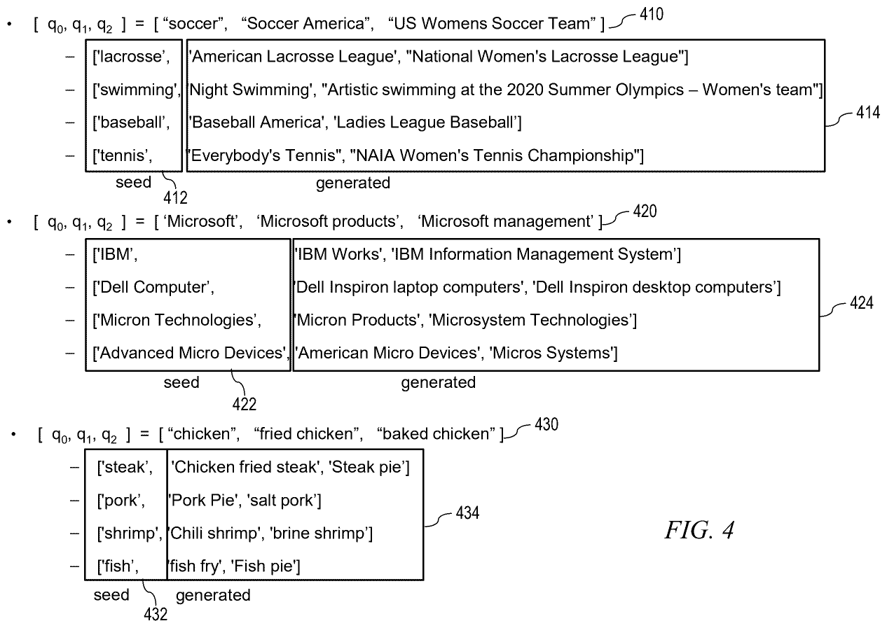

FIG. 4 is a diagram depicting example user and decoy sequences generated using the mechanisms of the illustrative embodiments. In each example 410-430, the user query sequence is shown as sequence [q0, q1, q2]. The seed decoy search queries 412, 422, and 432 are shown in the first box for each of a plurality of decoy query sequences for each example 410, 420, and 430. The subsequent decoy search queries generated by the application of the difference vectors are shown as the second box 414, 424, and 434. Each of the examples show coherent development of the original topic in the seed decoy search queries in a manner that mirrors that of the user submitted query.

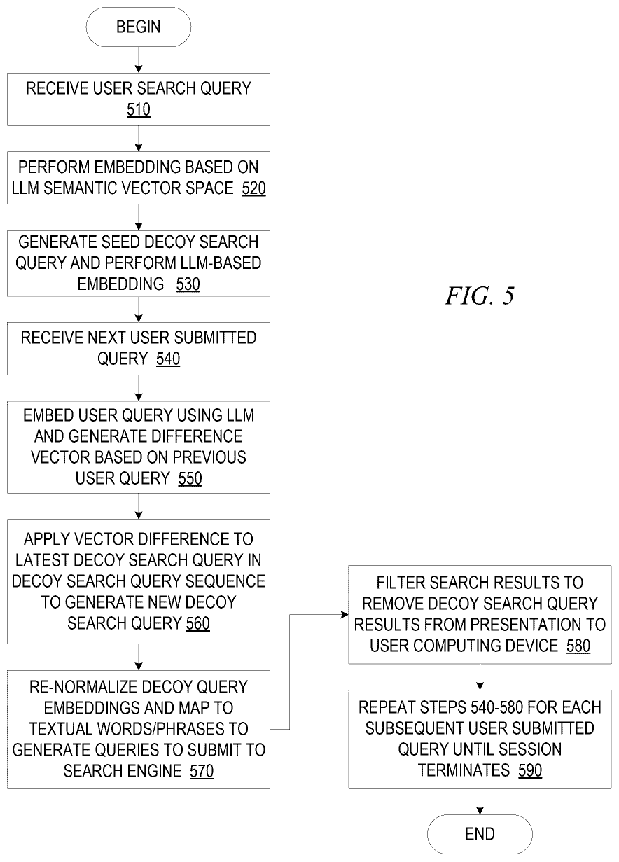

FIG. 5 presents a flowchart outlining example operations of elements of the present invention with regard to one or more illustrative embodiments. It should be appreciated that the operations outlined in FIG. 5 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 5, and may, in some cases, make use of the results generated as a consequence of the operations set forth in FIG. 5, the operations in FIG. 5 themselves are specifically performed by the improved computing tool in an automated manner.

As shown in FIG. 5, the operation starts by receiving a user search query (step 510). Based on the user search query, and an already established semantic vector space or embedding space of an LLM, the user search query is embedded (step 520) and a seed decoy search query is generated (step 530). Then, a next user submitted query is received (step 540). The user query is embedded and a difference vector is generated relative to the previous user submitted search query, e.g., the initial user search query (step 550). The vector difference is applied to the latest decoy search query to generate a next decoy search query in the decoy search query sequence (step 560). The vector embeddings of the decoy search query are re-normalized and mapped to textual words/phrases for generation of textual search queries that are submitted to the search engine (step 570). The search results returned for decoy search queries are filtered such that they are not presented to the user (step 580). The operation of steps 540-580 may be repeated for each subsequent user search query received until the user session terminates (step 590). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving a user search query sequence comprising at least one pairing of a first user search query and a second user search query that is subsequent to the first user search query in the user search query sequence;
generating, for the pairing, a difference vector between a vector embedding of the second user search query and a vector embedding of the first user search query; and
applying the difference vector to a vector embedding of a previous decoy search query to generate a subsequent decoy search query in a decoy search query sequence, wherein the vector embeddings of the first user search query, second user search query, and the previous decoy search query are generated by a large language model (LLM) based on a semantic embedding space associated with the LLM.

2. The method of claim 1, wherein a first perplexity metric of the decoy search query sequence is maintained within a predetermined tolerance of a second perplexity metric of the user search query sequence while generating subsequent decoy search queries in the decoy search query sequence.

3. The method of claim 1, wherein the pairing is one of a plurality of pairings in the user search query sequence, and wherein difference vectors are generated for each pairing of a subsequent user search query and a previous user search query in the user search query sequence, to generate a corresponding subsequent decoy search query in the decoy search query sequence.

4. The method of claim 1, wherein the previous decoy search query is a seed decoy search query generated by selecting a decoy search query term or phrase from within the semantic embedding space.

5. The method of claim 4, wherein the seed decoy search query is selected from terms or phrases corresponding to a topic of the first user search query in the user search query sequence.

6. The method of claim 1, wherein user search queries of the user search query sequence are submitted to a search engine along with decoy search queries of the decoys search query sequence, and wherein only results from the user search queries of the user search query sequence are returned to a source computing device of the user search queries.

7. The method of claim 1, wherein:
applying the difference vector to results of the vector embedding of the previous decoy search query in a vector embedding of the subsequent decoy search query,
the subsequent decoy search query is generated at least by normalizing and mapping the vector embedding of the subsequent decoy search query to textual words of a textual search query, and
the decoy search queries of the decoy search query sequence are submitted to a search engine along with user search queries of the user search query sequence.

8. A computer program product comprising:
one or more computer-readable storage media; and
program instructions stored on the one or more computer-readable storage media to perform operations comprising:
receiving a user search query sequence comprising at least one pairing of a first user search query and a second user search query that is subsequent to the first user search query in the user search query sequence;
generating, for the pairing, a difference vector between a vector embedding of the second user search query and a vector embedding of the first user search query; and
applying the difference vector to a vector embedding of a previous decoy search query to generate a subsequent decoy search query in a decoy search query sequence, wherein the vector embeddings of the first user search query, second user search query, and the previous decoy search query are generated by a large language model (LLM) based on a semantic embedding space associated with the LLM.

9. The computer program product of claim 8, wherein a first perplexity metric of the decoy search query sequence is maintained within a predetermined tolerance of a second perplexity metric of the user search query sequence while generating subsequent decoy search queries in the decoy search query sequence.

10. The computer program product of claim 8, wherein the pairing is one of a plurality of pairings in the user search query sequence, and wherein difference vectors are generated for each pairing of a subsequent user search query and a previous user search query in the user search query sequence, to generate a corresponding subsequent decoy search query in the decoy search query sequence.

11. The computer program product of claim 8, wherein the previous decoy search query is a seed decoy search query generated by selecting a decoy search query term or phrase from within the semantic embedding space.

12. The computer program product of claim 11, wherein the seed decoy search query is selected from terms or phrases corresponding to a topic of the first user search query in the user search query sequence.

13. The computer program product of claim 8, wherein user search queries of the user search query sequence are submitted to a search engine along with decoy search queries of the decoys search query sequence, and wherein only results from the user search queries of the user search query sequence are returned to a source computing device of the user search queries.

14. The computer program product of claim 8, wherein:
applying the difference vector to results of the vector embedding of the previous decoy search query in a vector embedding of the subsequent decoy search query,
the subsequent decoy search query is generated at least by normalizing and mapping the vector embedding of the subsequent decoy search query to textual words of a textual search query, and
the decoy search queries of the decoy search query sequence are submitted to a search engine along with user search queries of the user search query sequence.

15. A computer system comprising:
a processor set;
one or more computer-readable storage media; and
program instructions stored on the one or more computer-readable storage media to cause the processor set to perform operations comprising:
receiving a user search query sequence comprising at least one pairing of a first user search query and a second user search query that is subsequent to the first user search query in the user search query sequence;
generating, for the pairing, a difference vector between a vector embedding of the second user search query and a vector embedding of the first user search query; and
applying the difference vector to a vector embedding of a previous decoy search query to generate a subsequent decoy search query in a decoy search query sequence, wherein the vector embeddings of the first user search query, second user search query, and the previous decoy search query are generated by a large language model (LLM) based on a semantic embedding space associated with the LLM.

16. The computer system of claim 15, wherein a first perplexity metric of the decoy search query sequence is maintained within a predetermined tolerance of a second perplexity metric of the user search query sequence while generating subsequent decoy search queries in the decoy search query sequence.

17. The computer system of claim 15, wherein the pairing is one of a plurality of pairings in the user search query sequence, and wherein difference vectors are generated for each pairing of a subsequent user search query and a previous user search query in the user search query sequence, to generate a corresponding subsequent decoy search query in the decoy search query sequence.

18. The computer system of claim 15, wherein the previous decoy search query is a seed decoy search query generated by selecting a decoy search query term or phrase from within the semantic embedding space.

19. The computer system of claim 15, wherein user search queries of the user search query sequence are submitted to a search engine along with decoy search queries of the decoys search query sequence, and wherein only results from the user search queries of the user search query sequence are returned to a source computing device of the user search queries.

20. The computer system of claim 15, wherein:
applying the difference vector to results of the vector embedding of the previous decoy search query in a vector embedding of the subsequent decoy search query,
the subsequent decoy search query is generated at least by normalizing and mapping the vector embedding of the subsequent decoy search query to textual words of a textual search query, and
the decoy search queries of the decoy search query sequence are submitted to a search engine along with user search queries of the user search query sequence.
